(19) United States
(12) Patent Application Publication
(10) Pub. No.: US 2006/0066642 A1
(43) Pub. Date: Mar. 30, 2006

(54) Image display device

(75) Inventors: Yasuhiro Ookawara, Tokyo (JP); Tsutomu Sakamoto, Fukaya-shi (JP); Toshio Obayashi, Hiratsuka-shi (JP); Takayuki Arai, Hiratsuka-shi (JP); Masao Yanamoto, Ichihara-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/211,713

(22) Filed: Aug. 26, 2005

(30) Foreign Application Priority Data
Sep. 30, 2004 (JP) P2004-289120

(51) Int. Cl. G09G 5/10

(52) U.S. Cl. 345/690

(57) ABSTRACT

In an update operation of uneven luminance correction values, a display area of a flat display is handled as if it is divided into a plurality of small areas A to I. Then, in one update operation of the uneven luminance correction values, the uneven luminance correction values are updated only for one of these small areas A to I. Therefore, by performing the update operation of the uneven luminance correction values the same number of times as the number (9) of the small areas A to I, the uneven luminance correction values for the whole display area of the flat display are updated.

### CROSS-REFERENCE TO RELATED APPLICATION

This application is based upon and claims the benefit of priority from the prior Japanese Patent Application No. 2004-289120, filed on Sep. 30, 2004; the entire contents of which are incorporated herein by reference.

### BACKGROUND OF THE INVENTION

1. Field of the Invention

The present invention relates to an image display device, and more particularly, to an image display device having a function of correcting variation in luminance (uneven luminance) among display pixels.

2. Description of the Related Art

As an image display device, for example, a FED (field emission display) which is a flat image display device using field emission type elements has been conventionally known. In such an image display device, variation in luminance (uneven luminance) among display pixels occurs due to characteristic difference among the elements. Therefore, the image display device is provided with an uneven luminance correction function of correcting an image signal by measuring uneven luminance among the display pixels in advance, calculating uneven luminance correction values from the measurement results, and storing the uneven luminance correction values in a correction value memory.

Such an image display device requires updating of the uneven luminance correction values since luminance characteristics of the respective display pixels change with time. One of known techniques for updating the uneven luminance correction values is to measure values of currents that flow in the respective display pixels when a predetermined test signal is supplied thereto, and update the uneven luminance correction values stored in the correction value memory based on the measurement result of the currents (see, for example, Japanese Patent No. 3280176).

In the image display device described above, the currents cannot be measured while the display device is on and is actually displaying an image because the measurement of the currents in the display pixels through the use of the test signal during this period would visually bother a viewer.

Therefore, a possible method to update the uneven luminance correction values may be to measure the currents in the respective display pixels during a period between the power-on time of the image display device and the time of the start of the actual image display, or to measure the currents after the display device is turned off.

However, while the display device is off, there is a possibility that, for example, a power plug is pulled out of a receptacle after the image display device is turned off, so that the image display device is cut off from a power source. Further, it takes a lot of time to measure the currents in all the display pixels of the image display device to update the correction values. Therefore, if the measurement of the currents and the update of the uneven luminance correction values are performed while the image display device is off, there is a possibility that the image display device is cut off from the power source, resulting in the interruption of these operations halfway and the like.

Further, if the measurement of the currents and the update of the uneven luminance correction values are performed while the display device is on, due to the longtime required for these operations, it takes a long time for the image display to be actually started, which results in a longer risetime.

### SUMMARY OF THE INVENTION

It is an object of the present invention to provide an image display device capable of surely updating an uneven luminance correction value without causing any increase in a risetime or the like.

An image display device according to one of the aspects of the present invention is an image display device having an image display unit that displays an image, the image display unit including a plurality of display pixels to each of which a driving signal and a scan line signal from a scan line driver are supplied, and the image display device including: a correction value memory storing uneven luminance correction values for the respective display pixels; a test signal supply unit supplying a predetermined test signal as the driving signal to the display pixels; a current measuring unit which measures a current flowing through the scan line driver when the test signal supply unit supplies the test signal to each of the display pixels; and a control unit which executes, at a predetermined timing, an update operation including: sequentially supplying the test signal from the test signal supply unit, part of the display pixels of the image display unit being supplied with the test signal at one supply operation; measuring the currents flowing through the scan line driver by the current measuring unit; and updating the uneven luminance correction values in the correction value memory based on a result of the measurement of the currents, wherein said control unit executes the update operation of the uneven luminance correction values a plurality of times to update the uneven luminance correction values for all the display pixels of the image display unit.

### BRIEF DESCRIPTION OF THE DRAWINGS

FIG. 1 is a diagram showing a configuration of an image display device according to one embodiment of the present invention.

FIG. 2 is a chart to explain operations of the image display device in FIG. 1.

FIG. 3 is a chart to explain operations of the image display device in FIG. 1.

FIG. 4 is a chart to explain operations of the image display device in FIG. 1.

FIG. 5 is a chart to explain operations according to another embodiment of the present invention.

### DESCRIPTION OF THE EMBODIMENTS

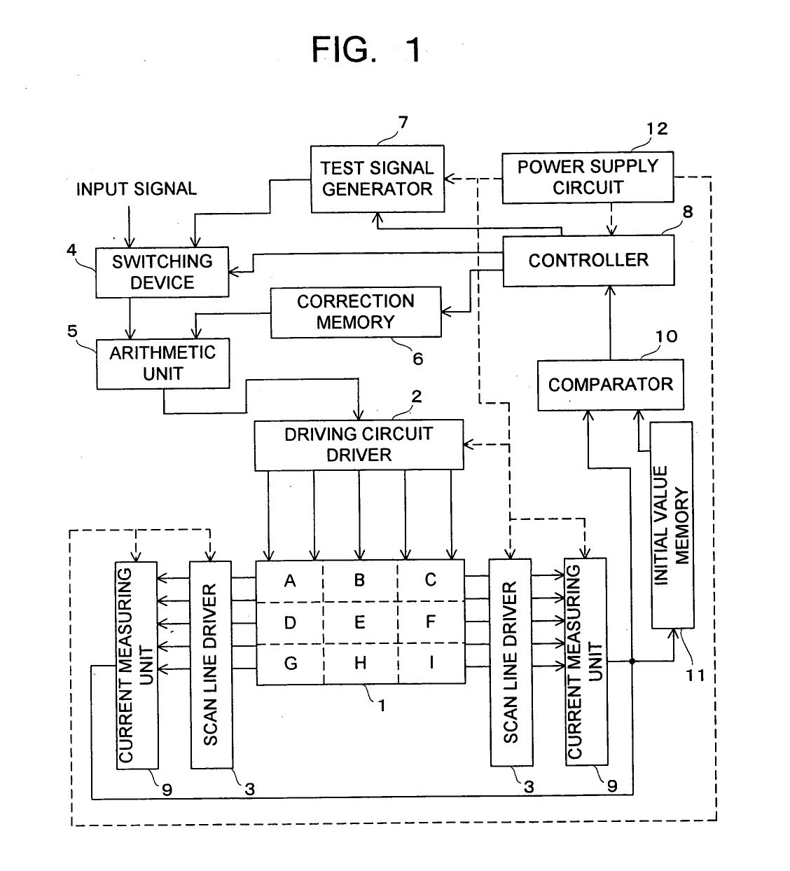

Hereinafter, embodiments of the present invention will be described with reference to the drawings. FIG. 1 schematically shows a configuration of an essential part of an image display device according to one embodiment of the present invention. In FIG. 1, 1 denotes a flat display as an image display unit, 2 denotes a driving circuit driver supplying a driving signal to the flat display 1, 3 denotes scan line drivers supplying a scan line signal to the flat display 1, 4 denotes a switching device, 5 denotes an arithmetic unit, and 6 denotes a correction value memory.

The flat display 1 has m (for example, 720) scan lines extending in a lateral (horizontal) direction, n (for example, 1280×3) signal lines extending in a longitudinal (vertical) direction to intersect with the scan lines, and m×n (for example, about 2760000) display pixels arranged near intersections of the scan lines and the signal lines. Each of the color display pixels consists of horizontally adjacent three display pixels. In this color display pixel, each of the three display pixels has a surface conduction type electron emitting element. The respective display pixels have red (R), green (G), and blue (B) phosphors each emitting light when irradiated with an electron beam emitted from the surface conduction type electron emitting element.

An input signal as a basis of image display is inputted to the arithmetic unit 5 via the switching device 4. The signal inputted to the arithmetic unit 5 is corrected based on an uneven luminance correction value for each display pixel stored in the correction value memory 6 to be supplied to the driving circuit driver 2. This signal is supplied to the flat display 1 from the driving circuit driver 2. Consequently, the flat display 1 displays an image with uneven luminance being corrected.

In FIG. 1, 7 denotes a test signal generator, 8 denotes a controller, 9 denotes current measuring units, 10 denotes a comparator, 11 denotes an initial value memory, and 12 denotes a power supply circuit. The test signal generator 7 generates a predetermined test signal. This test signal is used, for example, when the uneven luminance correction values for the respective display pixels stored in the correction value memory 6 are updated. The controller 8 controls the timing for the generation of the test signal by the test signal generator 7 and the execution of an update operation of the uneven luminance correction values. The controller 8 starts executing the update operation of the correction values at a predetermined timing that has been set in advance (for example, the power-on time or the power-off time).

In the update operation of the uneven luminance correction value using the test signal, the controller 8 controls the switching device 4 so that a driving signal that is to be inputted to the driving circuit driver 2 is switched from the input signal for normal image display to the test signal sent from the test signal generator 7. Then, the current measuring unit 9 measures currents that flow when the test signal from the test signal generator 7 are applied to the display pixels.

In the case of the surface conduction type electron emitting element, a current value measured by the current measuring unit 9 has a correlation with the intensity of the emitted electron beam. Therefore, when the current measuring unit 9 measures the current flowing through the scan line driver 3 of each display pixel (element) to which the driving signal has been supplied, it is possible to detect a change of the intensity with time, and the uneven luminance value is updated so as to compensate this change.

In the update operation of the uneven luminance correction values in this embodiment, a display area of the flat display 1 is handled as if it is divided into a plurality of (9 in the example in FIG. 1) small areas A to I, as shown in FIG. 1. Then, in one update operation of the uneven luminance correction values, the uneven luminance correction values for only one of these small areas A to I are updated. At this time, the order in which the small areas A to I become targets of the update of the uneven correction values is set in advance, and the update of the uneven luminance correction values for the small areas A to I proceeds according to this order. The update may start from “A” at the end portion to proceed in the order such as A→B→C . . . I, or may start from “E” at the center.

Therefore, when the update operation of the uneven luminance correction values is executed the same number of times as the number of the small areas A to I (9 in the example in FIG. 1), the uneven luminance correction values for the whole display area of the flat display 1 are updated. This can shorten the time for one update operation of the uneven luminance correction values, compared with a case where the uneven luminance correction values for the whole display area is updated by one operation.

Initial values of the current values measured by the current measuring units 9 are stored in the initial value memory 11. The measurement of the initial values of the current values and the setting of the uneven luminance correction values based on the initial values of the current values (initial characteristic test) are performed at the time of manufacture of products.

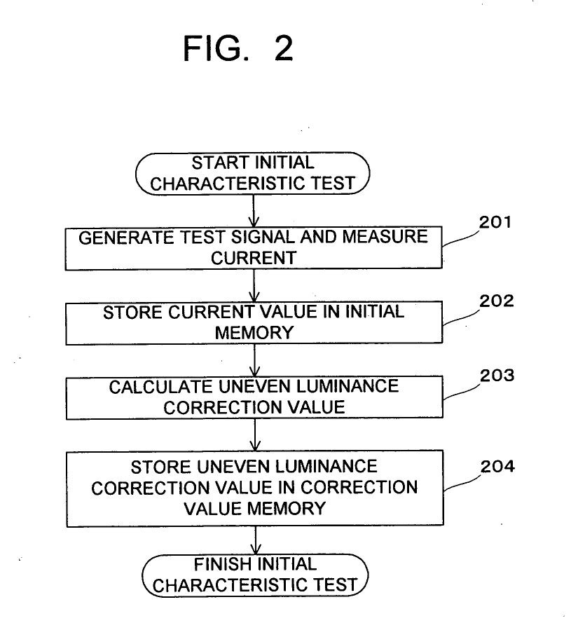

FIG. 2 shows processes of the initial characteristic test. As shown in the drawing, in the initial characteristic test, the test signal generator 7 generates the test signal, and the current measuring units 9 measure the currents that flow through the scan line drivers 3 when the test signal is applied to the display pixels (elements) (201).

Then, the initial values of the currents are stored in the initial value memory 11 (202). Further, the uneven luminance correction values are calculated from the initial values of the currents (203) and the calculated uneven luminance correction values are stored in the correction value memory 6 (204), and then the processing is finished.

An example of a method for calculating the uneven luminance correction value is to compare the measured value with a predetermined designed value and divide the designed value by the measured value. Concretely, for example, if the measured value is 4.0 mA while the designed value is 4.4 mA, the correction value is 1.1.

In the above-described manner, the initial characteristic test is conducted, so that initial values of the uneven luminance correction values are set. However, the characteristics of the elements constituting the respective display pixels change with time. This necessitates updating of the uneven luminance correction values.

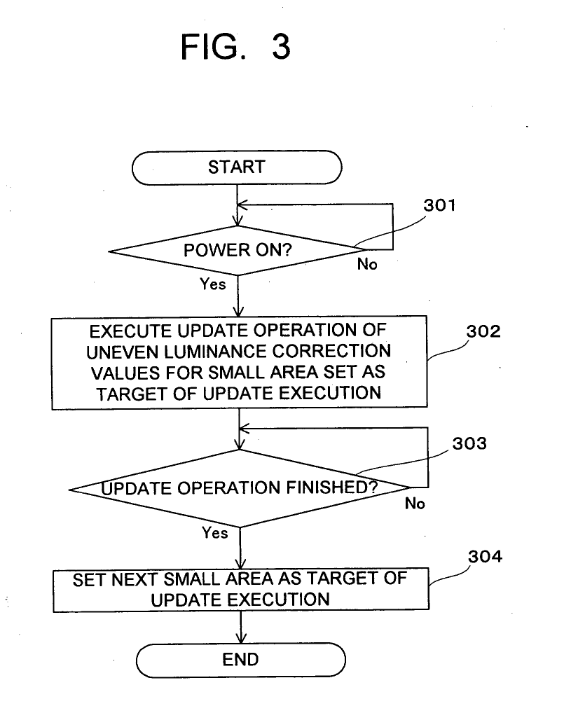

In this embodiment, as shown in FIG. 3, the controller 8 monitors whether or not power has been turned on in a standby state (301), and if YES, the small area for which the update operation of the uneven luminance correction values is to be executed next (a small area set as a target of the update execution), for example, the small area A is subjected to the update operation of the uneven luminance correction values in the predetermined order (302). Then, when the update operation of the uneven luminance correction values for this small area is finished (303), the next small area (for example, the small area B) is set as the target of the update execution (304), and then the processing is finished.

Consequently, at the next power-on time, the execution of the update operation of the correction values is started for the next small area (the small area B in the above example), and when power is turned on totally 9 times, the update of the uneven luminance correction values of the whole display area of the flat display 1 is completed.

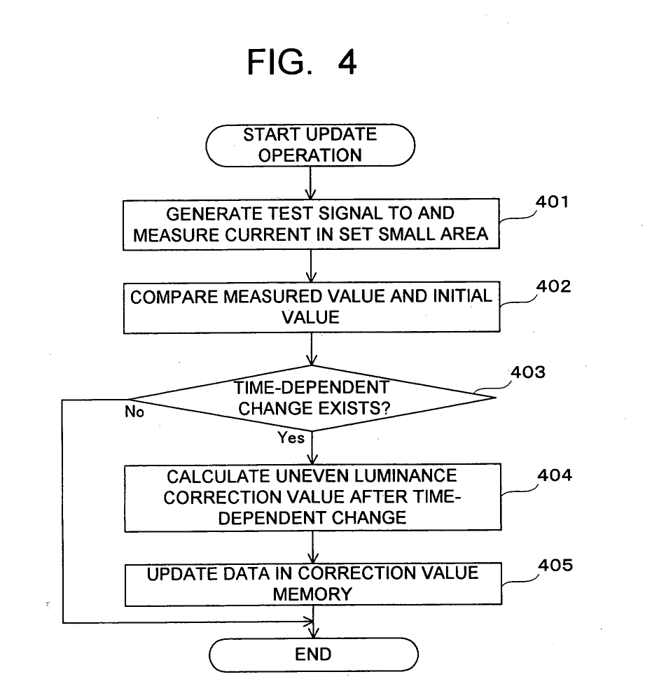

The update operation of the uneven luminance correction values described above is executed in a manner shown in FIG. 4. Specifically, when the update operation is started in response to a request from the controller 8, the generation of the test signal by the test signal generator 7 to the small area that has been set as the target for the update execution as described above and the measurement of the currents by the current measuring unit 9 are first executed (401).

Next, the comparator 10 compares the measured current values with the initial values of the current values of the respective display pixels stored in the initial value memory 11 (402). Consequently, the existence or not of the time-dependent change of the luminance characteristic in each of the display pixels and its magnitude are detected. Then, the controller 8 judges whether or not the time-dependent change exists (403), and if NO, the processing is finished. If YES, uneven luminance correction values to be newly set after the time-dependent change are calculated based on the comparison results (404), and data on the uneven luminance correction values for the respective display pixels stored in the correction value memory 6 are updated (405).

Whether or not the time-dependent change exists can be judged, for example, in such a manner that the time-dependent change is judged as not existing when a difference between the initial value of the current value and the measured value of the current value is smaller than a preset threshold value, and the time-dependent change is judged as existing when the difference is equal to or larger than the threshold value. Further, the uneven luminance correction values can be calculated in the same manner as in the above-described case.

As described hitherto, in this embodiment, when the image display device is turned on and the power supply circuit 12 starts supplying power to each unit, the execution of the update operation of the uneven luminance correction values is started. At this time, in one update operation of the uneven luminance correction values, instead of updating the uneven luminance correction values for the display pixels of the whole display area of the flat display 1, the uneven luminance correction values are updated only for one of the small areas, namely, part of the display pixels. Then, when power is turned on a plurality of times, the uneven luminance correction values are updated for all the display pixels of the whole display area of the flat display 1. Therefore, it is possible to shorten the time required for one update operation of the uneven luminance correction values, which makes it possible to execute the update operation of the uneven luminance correction values in a short time from the power-on time to the start of the actual image display. Therefore, it is possible to surely update the uneven luminance correction values without causing any increase in the risetime.

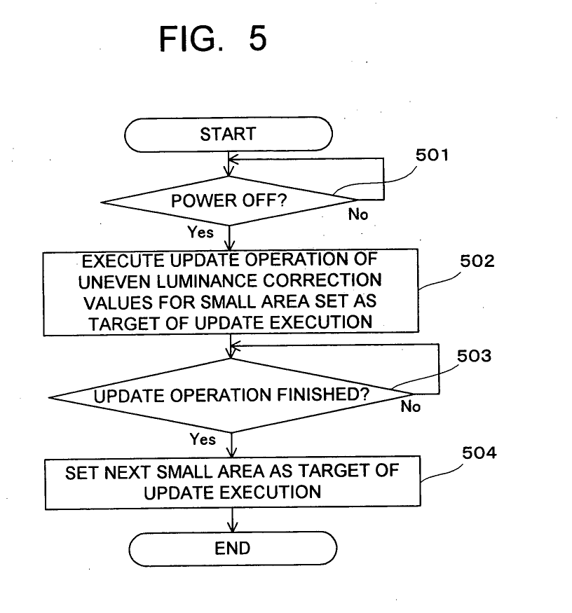

FIG. 5 shows an execution timing of the update operation of the uneven luminance correction values according to another embodiment. As shown in the drawing, in this embodiment, the controller 8 monitors whether or not power has been turned off while the image display device is in operation (501), and if YES, the small area for which the next update operation of the uneven luminance correction values is to be executed (the small area that has been set as a target for update execution), for example, the small area A is subjected to the update operation of the uneven luminance correction values in the predetermined order (502). Then, when the update operation of the correction values for this small area is finished (503), the next small area (for example, the small area B) is set as the target for the update execution (504), and then the processing is finished.

Consequently, at the next power-off time, the execution of the update operation of the correction values is started for the next small area (the small area B in the above example), and when the power is turned off totally 9 times, the update of the uneven luminance correction values for the whole display area of the flat display 1 is completed.

This embodiment can also shorten the time required for one update operation of the uneven luminance correction values. Therefore, even if the image display device is cut off from the power source because a power supply plug is pulled out from a receptacle after the power is turned off by, for example, a remote controller or the like, it is highly possible that, before such a situation occurs, the update operation of the uneven luminance correction values can be finished, which makes it possible to more surely update the uneven luminance correction values.

It should be noted that the present invention is not limited to the embodiments described above, and it goes without saying that various modifications can be made therein. For instance, the above embodiments have described the cases where the flat display 1 is divided into the 9 rectangular small areas A to I when the uneven luminance correction values are updated. However, the shape of the small areas and the dividing number are not limited to those in these examples, and may be any. Further, the timing for starting the update operation of the uneven luminance correction values is not limited to either one of the power-on time and the power-off time, but the execution of the update operation may be started, for example, both at the power-on time and the power-off time.

What is claimed is:

1. An image display device having an image display unit that displays an image, the image display unit including a plurality of display pixels to each of which a driving signal and a scan line signal from a scan line driver are supplied, and the image display device, comprising:
a correction value memory storing uneven luminance correction values for the respective display pixels;
a test signal supply unit supplying a predetermined test signal as the driving signal to the display pixels;
a current measuring unit which measures a current flowing through the scan line driver when said test signal supply unit supplies the test signal to each of the display pixels; and
a control unit which executes, at a predetermined timing, an update operation including:
sequentially supplying the test signal from said test signal supply unit, part of the display pixels of said image display unit being supplied with the test signal at one supply operation; measuring the currents flowing through the scan line driver by said current measuring unit; and
updating the uneven luminance correction values in said correction value memory based on a result of the measurement of the currents, wherein said control unit executes the update operation of the uneven luminance correction values a plurality of times to update the uneven luminance correction values for all the display pixels of said image display unit.

2. The image display device as set forth in claim 1,
wherein said control unit divides a whole image display area of said image display unit into a plurality of small areas, and at each power-on time, said control unit executes the update operation of the uneven luminance correction values sequentially for each of the small areas resulting from the division.

3. The image display device as set forth in claim 2,
wherein at each power-on time, said control unit executes the update operation of the uneven luminance correction values sequentially for each of the small areas in a predetermined order, and when the power is turned on the same number of times as the number of the small areas, said control unit updates the uneven luminance correction values for all the display pixels of said image display unit.

4. The image display device as set forth in claim 1,
wherein said control unit divides a whole image display area of said image display unit into a plurality of small areas, and at each power-off time, said control unit executes the update operation of the uneven luminance correction values sequentially for each of the small areas resulting from the division.

5. The image display device as set forth in claim 4,
wherein at each power-off time, said control unit executes the update operation of the uneven luminance correction values sequentially for each of the small areas in a predetermined order, and when the power is turned off the same number of times as the number of the small areas, said control unit updates the uneven luminance correction values for all the display pixels of said image display unit.
